(19) United States
(12) Patent Application Publication
(10) Pub. No.: US 2019/0353554 A1
(43) Pub. Date: Nov. 21, 2019

(54) SYSTEM AND METHOD OF DETECTING CHANGES IN STRUCTURAL HEALTH OF A COMPOSITE PANEL

(71) Applicants: Purushotam MAHAVADI, Stockelsdorf (DE); MAHAVADI MANAGEMENT AND TECHNOLOGY SERVICES GMBH, Stockelsdorf (DE)

(72) Inventor: Purushotam MAHAVADI, Stockelsdorf (DE)

(21) Appl. No.: 16/077,783

(22) PCT Filed: Feb. 17, 2017
(86) PCT No.: PCT/IB2017/050916

§ 371 Date: Aug. 14, 2018

(30) Foreign Application Priority Data
Feb. 19, 2016 (IN) 201641005836

(51) Int. Cl. G01M 5/00; G01N 29/07; G01N 29/36; G01N 29/12

(52) U.S. Cl. CPC G01M 5/0033; G01N 29/07; G01N 29/36; G01N 2291/0258; G01M 5/0066; G01N 2291/011; G01N 2291/0231; G01N 29/12

(57) ABSTRACT

The invention relates to a system and method for detecting the changes in the structural health of a composite panel, more specifically structural or material changes caused to the composite panel as a result of de-lamination, distortion or breakage of the material at the molecular level rendering the composite panel unfit for use.

### TECHNICAL FIELD

It is a known fact that composite panels are used in in all walks of life including the manufacture of anti-ballistic gear which is used by defense systems to protect human beings, vehicles and objects from ballistic damage. It is conventional practice for an organization supplying anti-ballistic gear to provide long term assurances of performance to the agencies procuring such composite panels. The time period for this performance assurance varies from two years to ten years. The performance assurance provided is simply based on the sample testing and ballistic testing methods to test if the manufacturing process parameters such as pressure, temperature, material tolerances, humidity, room temperature have been adhered to. Moreover, manufacturing process parameters such as pressure and temperature can be measured only on the surface of the composite panel and not at the interfaces. The interfaces of a composite panel constitute the intra layers of the composite structure forming the composite panel. Pursuant to such testing most manufactures have still not been able to identify a material change to composite panels manufactured. It is part of existing practice to follow the same process steps and parameters in manufacturing the panels and assume that all interfaces of the panel are subjected to the same parameters and therefore exhibit the same characteristics. These assumptions are not always true for panels which are made out of different types of materials like ceramic and Aramid. Moreover, hard materials like ceramic have manufacturing tolerances and surface irregularities which hinder proper interface bonding.

Composite panels are subjected during their lifetime to external forces such as varying environmental conditions. Additionally, they may also be subject to external forces such as rough use by the user of the composite panel. This holds especially true for composite panels used by the defense systems as these composite panels could be subjected to external forces such as varying environmental conditions and rough-use conditions arising out of the professional hazards involved. As a result it is likely that the material properties which contribute to the structural health of these panels can change or deteriorate. This can happen as a result of their exposure to changing external forces exerted upon them when they are use.

During the life time of these composite panels, they are exposed to extreme environmental conditions and other dynamic and static forces such as:

a) Exposure to temperature between the range of −40éC to +90éC

b) Swift change in humidity from 0 to 100%

c) Immersion in sea water and river water

d) Exposure to direct sun light or infrared or ultra violet rays

e) Highest order of vibrations during transportation

f) Swift changes in altitude pressure

g) Accidental exposure of the composite panel to hard surfaces.

h) Electric and magnetic fields

All of the aforementioned environmental effects cause a change to the material properties which contributes to the structural health of composite panels thereby causing a deterioration in its performance.

Additionally, by their very nature, such composite panels are subject to distortion due to ballistic damage and other forms of impact based damage. These forms of damage cause cracking, delamination and to a very large extent causes a change in the physical and material characteristics of the composite panel. Once a composite panel becomes damaged, it results in a drastic decrease to its impact resistance properties and anti-ballistic capabilities thereby affecting its performance.

The inventor has developed a system and method to monitor the changes in material properties and at the interfaces by monitoring changes in intra-layer properties such as the breakages in ceramics or other hard layers and the interlayer bonding properties (delamination of layers because of environmental and usage and storage depended conditions) of composites thereby determining the changes in the structural health of the composites.

The method involves the transmission of wave packets from one end of the composite panel which are subsequently received at the other end of the composite panel at selected frequencies by way of using sensors which are embedded into the composite panel. A wave packet is a short burst of a localized wave action that travels as a unit. Based on the structural health condition of the medium, the following wave characteristics of these wave packets are thereafter measured:

a. Travel time

b. Amplitude

c. Phase

d. Shape

A part of each wave packet transmitted gets attenuated. The extent of attenuation of each wave packet depends on the material properties of the medium such as the strength of the composite panel and its intra-layer and inter layer bonding. These wave packets take time to reach the receiver and their travel time depends on the material properties such as interlayer bonding (de-lamination), distortion of individual or multiple panels (distortion) or intra layer strength (breakages) of the composite panels which contribute to the structural health of the medium. The wave packets undergo reflections at the boundaries of the composite panel before reaching the receiver because of which the travel time may increase thereby also resulting in a change in the amplitude of the wave packets. Each wave packet may also change its phase and shape depending on the material properties of composite panel and the relative position of the sensors. The final wave packet reaching the receivers is therefore the sum of each individual wave packet reaching the receivers at the same time.

Alternatively, one can use two or more receivers at the same time. The use of additional receivers allows one to determine whether there is any difference in the material properties of the path through which these waves travel. If there is any difference in the material properties of the path through which these waves travel, then there would be a difference in the wave characteristics of each of these waves received by the sensor. This would in-turn help in identifying that there is change in the structural health of the composite panel.

The aforementioned characteristics of the wave packet are influenced by the medium that it travels through. These material characteristics are reflected in the properties of the received signal. Using several receiver sensors at the same time it is possible to map any changes in the structural health of the composite panel.

The following are the steps involved in determining the appropriate wave packet to be sent through the composite panel in order to detect any change in the structural health of a composite panel.

Step One: Determination of Pass Frequency of the Medium:

The method involves the propagation of continuous periodic waves through a composite panel. The composite panel acts as a band pass filter as it allows propagation of waves which are part of the continuous periodic waves of certain frequencies and attenuates or suppresses all other waves which do not belong to that frequency range. This frequency at which the waves propagate with less difficulty from transmitter to the receiver is called the pass frequency (Pass Frequency).

This Pass Frequency depends on the material properties of the composite panel and the position of the sensors. The Pass Frequency changes if the material properties of the composite panel change. Thus, any change in the Pass Frequency indicates a change in the material properties as the path through which the waves have travelled has been materially altered. The strength of the wave propagated depends on the relative positions of the transmitter and the receiver. As a number of sensors can be embedded into the composite panel as indicated above under the heading ‘field of the invention_, the signals received by each sensor differ in frequency, amplitude and phase due to the relative position of the sensor used to transmit the signal and the sensor used to receive the signal in the composite panel. The Pass Frequency is thereafter determined by plotting the amplitude and phase of these signals received by the sensor receiving the signal as a function of input signal frequency. The result obtained consists of waves of different amplitude and the wave frequency of the wave with the highest amplitude is selected in order to determine the Pass Frequency. The Pass Frequency is thereafter selected for further analysis.

Step Two: Use of Wave Packets at Selected Frequencies for Characterization of the Composite Panel:

Once the Pass Frequency has been determined, wave packets of that particular Pass Frequency are transmitted into the composite panel. The wave characteristics such as amplitude, shape, phase and travel time of the continuous periodic wave and wave packets of that Pass Frequency are measured in order to find any change in the structural health of the composite panels. Transmitting a wave packet through the transmitter and measuring the time taken for it to reach a receiver, one can calculate the velocity of the wave packet travelled through the medium. The speed, amplitude or attenuation of this wave packet is a measure of the quality or state of the medium. Similarly, the shape or distortion in the received wave packet is a measure of the number of reflections it has undergone and medium it has travelled. The wave packet samples the properties of the medium through which it is travelling and delivers the wave characteristics of final wave packet to the receiver in the form of amplitude, shape and phase. These properties of received wave packets are measured at different points in time in the service life of the composite panel.

Any changes in the interlayer bonding (de-lamination), distortion of individual or multiple panels (distortion) or intra layer strength (breakages) of composite panels directly affects the strength of the panels. Such delamination, distortion or breakages influence the wave characteristics of such waves passing through the composite panel. The changes in the characteristics of the composite panels resulting from such delamination, distortion or breakages also affect the propagation of continuous periodic waves or wave packets of a particular Pass Frequency. The changes in intra-layer structural integrity, interlayer spacing or interlayer bonding or breakages or micro cracks in the panel also changes its wave characteristics. The developed method makes use of the wave characteristics of wave packets across the panel to enable the detecting of such changes over time. These changes can be measured and recorded as and when required and compared with the original data recorded immediately after manufacturing and before supplying the composite panel to the customer.

When continuous periodic waves are propagated through a composite panel, the resonance and the wave characteristics of these waves being propagated are measured by using sensors embedded within the panel or placed on the surface of the panel and suitable measurement equipment. Similarly, the travel time is also measured for wave packets using sensors placed at different locations. The travel time of these wave packets varies as each signal reaches different sensors at a different time. These wave packets are affected by the material properties of the medium through which they are travelling, thus providing information on the strength and properties of the composite panel as they travel. As a result, the amplitude, phase and shape of these wave packets vary based on the current condition of the composite panel. The results obtained after measuring such wave characteristics and the travel time of these wave packets are recorded before the composite panels are supplied to the customer. All these properties of the wave packet are recorded as ‘Signature Properties_ of that particular composite panel. Signature Properties are therefore defined as those inherent properties of the wave packet travelling through the composite panel recorded subsequent to the manufacture of the composite panel. Such Signature Properties are an indication of material properties such as the interlayer and the intra-layer bonding or lamination strength of the composite panel. Any change to the Signature Properties would be an indication of distortion or breakage of one or more layers of the composite panel.

The present invention is aimed at detecting any changes in the structural health of these composite panels as a result of various external conditions. Initial baseline tests are conducted in order to create a standard result for a composite panel, and the wave characteristics of the composite panel at the time of manufacture are recorded by the manufacturer. The composite panel is then tested by the manufacturer after a certain period of time and the wave characteristics of the composite panel are recorded again and compared with the standard results. These subsequently Recorded Properties are referred to herein as ‘Recorded Properties_. More specifically, Recorded Properties are therefore defined as those properties of the wave packet travelling through the composite panel recorded at any time after the supply of the composite panel by the manufacturer to any person. Any significant difference in the recorded results from the standard results would imply that the composite panels have undergone a structural or material change such as de-lamination, distortion or breakage or the material at the molecular level and that they may not be accordingly fit for use.

### BACKGROUND AND PROBLEMS WITH THE PRIOR ART

The following are the conventional methods of detecting or analyzing the health condition of a composite material:

1. Embedding fiber optic sensors for strain measurement

2. Microelectromechanical system (MEMS) accelerometers for vibration measurement

3. Active ultrasonics

4. Passive acoustic emission monitoring, and

5. Electromechanical impedance measurements

Furthermore, the use of ultrasonic guided waves for nondestructive evaluation of structures is rapidly expanding due to increased understanding of the underlying wave mechanics and improvements in sensors and signal processing. These methods have been developed mainly with regard to identifying any structural damage to a single layer in the composite. However, none of the above methods provides for an inbuilt system to monitor and analyze the structural health of the composite material as a whole.

### PRIOR ART

The following inventions have been identified as possible prior art to the present invention:
a. U.S. Pat. No. 6,370,964 B1 discloses a diagnostic layer and methods for detecting the structural integrity of composite and metallic materials.

The invention relates to a layer with an embedded network of distributed sensors and actuators that can be surface mounted or embedded in a composite structure for monitoring its structural condition and for detecting anomalies in the hosting metallic or composite structures.

The system comprises the following:
1. A diagnostic layer which consists of thin dielectric substrate, a plurality of sensors spatially distributed on the substrate
2. A plurality of conductive elements in the substrate for electrically connecting the sensors to an output lead.
3. The layer can also include an actuator or a plurality of actuators distributed on the substrate.
4. The system also consists of a signal receiver unit electrically coupled to the output lead for receiving output signals from the sensors. This coupling may be by wireless means
5. The system also consists of signal generating unit electrically connected to the output lead for providing an input signal to the actuators.

Working:
1. The first input signal is transmitted to the actuator and a first set of output signal is received
2. After a certain period of time, a second input signal is transmitted to the actuator and a second set of output signals are received.
3. The first set and the second set of output signals are compared to determine a difference between the two.
4. This difference represents the change in structural condition of the material and may indicate the location, the size of damage and the progression of curing.

The aforementioned invention deals with a system consisting of a dielectric substrate or a network of sensors and the method adopted in the same is completely different from that of the present invention wherein sensors, actuators or impulse generators are used to detect the resonance properties of the composite panel and not the properties of the dielectric layer as mentioned in the prior art. The disadvantage of the aforementioned invention in comparison to the subject invention is that it employs a large number of sensors in combination with conducting material for conducting signals within the composite material. The subject invention can be worked by using not more than two sensors to produce the desired result of detecting a change to the structural health of a composite panel, and without the necessity of adding any conducting material for conducting signals within the composite material.
b. WO9119173 discloses a method for detecting the structural integrity of composite structures. The invention relates to a method and system for non-destructively evaluating the structural integrity of a mechanical component constructed from fiber composites, specifically for assessing stiffness, strength and damping characteristic of a composite structure.

The system comprises the following:
1. Sensors and actuators which are placed on the composite material
2. The sensors are used for sensing strain or motion and may be laser vibro-meters or optical sensors.
3. Environmental sensors can also be used for the compensation of environmental effects.
4. Signal conditioning processes such as pre-amplification, powering, signal summation, signal differencing, amplification, filtering or phase control is performed on sensor and actuator signals if necessary.
5. The system also consists of a signal analyzer.

Working:
1. The signal is transmitted into the composite material through the signal input unit
2. The signal is received by an output unit
3. The frequency of the signal is measured and recorded
4. After a certain period of time, the frequency of a similar signal is measured and recorded.
5. Any difference between the signals would indicate stiffness change thereby inferring a corresponding change in strength or corresponding increase in damage to the said composite structure.

The aforementioned system and method deals with the vibration of the entire composite and also consists of an environmental model which calibrates the results considering the external environmental influence on the composite material. The present invention does not involve any vibration of the composite panel but deals with the measurement of the wave characteristics of a continuous periodic wave and wave packets of a particular Pass Frequency in order to determine the structural health of the composite panel. The objective of the aforementioned invention is to determine the structural damage to the composite panel by monitoring the extent of structural damping. The disadvantage of the aforementioned invention is that the sensors are placed on the surface of the composite structure which will not enable a user to measure the intra-layer properties of the composite structure.

U.S. Pat. No. 4,983,034 deals with providing a system and method for the measurement of distributed strain well suited for use in sensing the strain of a composite structure.

The invention consists of:

a) A composite structure comprising of composite material

b) An optical fiber which is embedded into the composite material

Working:
1. The optical fiber embedded into the composite material is subjected to strain by varying the optical energy transmitted through an optical source.
2. A reference signal representative of the modulated optical energy is recorded
3. Furthermore, the sensor senses the polarization state of the optical energy backscattered from the fiber below a selected frequency
4. Increasing the selected frequency to correspond to a selected location and mixing a portion of the optical energy backscattered from the fiber with a portion of the reference signal to produce a beat signal representative of strain at a selected location of the composite.
5. The aforementioned invention deals with subjecting the composite to strain by varying the optical energy and involves the production of a beat signal representative of strain at a selected location. The method would only help in detecting the strain at a particular location of a composite and not the composite as a whole. Moreover the method does not involve the measurement of resonance properties or the travel time of a signal.

### OBJECTS OF THE INVENTION

The main object of the invention is aimed at detecting any change in the structural health of the composite panel.
A further object of the invention is to detect any continuous periodic wave transmitted through a composite panel.
A further object of the invention is to detect the Pass Frequency of the continuous periodic wave transmitted through the composite panel
A further object of the invention is to detect any wave packet of a selected Pass Frequency transmitted though the composite panel.
A further object of the invention is to measure wave characteristics such as amplitude, phase, and shape of the signal received by the receiver sensors as a result of the continuous periodic wave transmitted through the composite panel.
A further object of the invention is to measure wave characteristics such as amplitude, phase shape and travel time of the signal received by the receiver sensors as a result of the wave packet of a selected Pass Frequency transmitted through the composite panel.

### STATEMENT AND SUMMARY OF THE INVENTION

According to the invention there is, therefore, provided a system, method, process and apparatus to detect any change in the structural health of a composite panel
(a) A primary mechanism or means of detecting any change in the structural health of the composite panel.
(b) An auxiliary mechanism of detecting any continuous periodic wave propagated through a composite panel and measured by using suitable measurement equipment
(c) An auxiliary mechanism of detecting any wave packet of a selected Pass Frequency transmitted through a composite panel and measured by using suitable measurement equipment.
(d) An auxiliary mechanism of measuring the wave characteristics of the continuous periodic wave such as amplitude, shape and phase.
(e) An auxiliary mechanism of measuring the wave characteristics of the wave packet of a selected Pass Frequency such as amplitude, shape, phase and travel time.

### DETAILED DESCRIPTION OF THE INVENTION

The description of the preferred embodiment is meant to demonstrate the broad working principles of the invention without limitation as to possible adaptations, extensions, applications etc., which would be obvious to a person skilled in the art. In the interest of brevity and for the purposes of exemplary explanation, references have been made to a system, depicted in FIGS. 1, 2, 3, 4 and 5 herein without limitation, to describe the invention which is essentially directed toward catering to the problem of detecting the structural health of composite panels.

### BRIEF DESCRIPTION OF THE DRAWINGS

FIG. 1 describes a schematic wherein wave packets are propagated through a composite panel in which sensors have been placed on the surface or within the composite panel.

FIG. 2 describes the placement of sensors within the composite panel wherein these sensors are used as both signal transmitters and signal receivers.

FIG. 3 describes the placement of sensors T1, R1, R2, R3, R4, R5 and R6 embedded in the composite panel wherein sensor T1 is used as a signal transmitter and sensors R1, R2, R3, R4, R5 and R6 are used as signal receivers. The sensor pairs R1 and R6, R2 and R5, R3 and R4_ are positioned equidistant to the transmitter sensor and preferably located on the same layer as the transmitter sensor. Therefore, assuming the composite panel is uniform and has uniform material properties all over the panel. Hence the wave packet experiences same medium in reaching each equidistantly placed sensor pair (namely R1:R6 and R2:R5 and R3:R4) resulting in same signals at each pair of sensors.

Any difference in the wave characteristics of the signals received by each sensor pairs R1:R6 or R2:R5 or R3:R4 indicates a difference in the change in the material properties of the path through which the waves have travelled to reach each sensor.

FIG. 4 describes the placement of sensors S1, S2 and S3 within the composite panel wherein sensor S1 is used as a signal transmitter and sensors S2 and S3 are used as signal receivers. Sensors S2 and S3 are positioned equidsitantly to the Transmitter S1. Therefore, any difference in the wave characteristics of the signals received by sensors S2 and S3 indicates a difference in the change in the material properties and the non uniformity of material properties in the panel.

FIG. 5 describes a concept of signal generation and recovery in the invention wherein the signal is transmitted by the signal transmitter (Sig in) and enters the composite panel through the signal transmitter. The signal is thereafter received by the signal receiver (Sig out), amplified by the pre-amplifier, recovered by the Signal recovery unit and processed by the Signal processing unit.

FIG. 6 describes a composite panel which is subjected to the detection of its structural health sample wherein receiver sensors are placed at positions L and R and the transmitter sensor is placed at position C. The tone generator (8) represents the control unit which sends the signal through C into the composite panel. The signals received at L and R are then amplified by a pre-amplifier (4). The lock-in amplifier (5) as described thereafter processes, recovers and measures the wave characteristics of the signal.

FIG. 7 shows a composite panel and amplitude-frequency plot based on results obtained after measuring the wave characteristics of the said composite panel sample using the structural health monitoring system. A composite panel sample with the attributes 12 cm width, 60 cm long and 0.6 cm thickness was selected. The composite panel has been marked with the letters L, C and R indicating the left edge, center portion and right edge of the composite panel respectively. The composite panel has been marked with the letter D between L and C indicating the position of the defect in the composite panel. Three sensors in the form of piezoelectric disks of 0.5 mm thickness each were embedded. Two piezoelectric disks were placed at the edges L and R of the panel and one is positioned at C at the center of the panel. The piezoelectric discs at L and R are positioned equidistantly to the piezoelectric disk at C. The piezoelectric disk at C will act as a transmitter-sensor and the piezoelectric disks at the edges L and R will act as the receiver-sensors. The defect has been marked as D situated in between the transmitter sensor and the receiver sensor on the left edge.

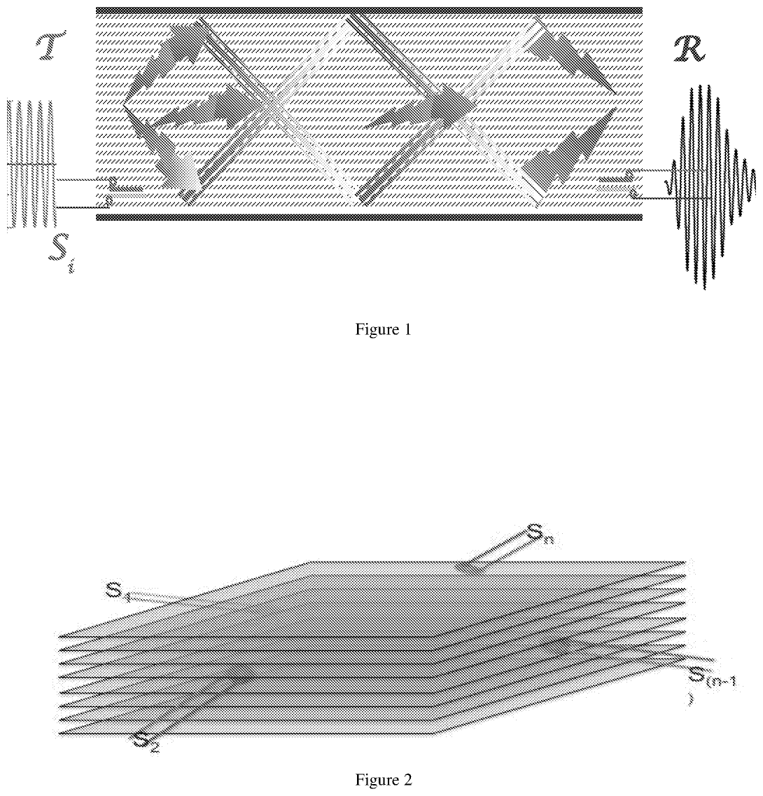

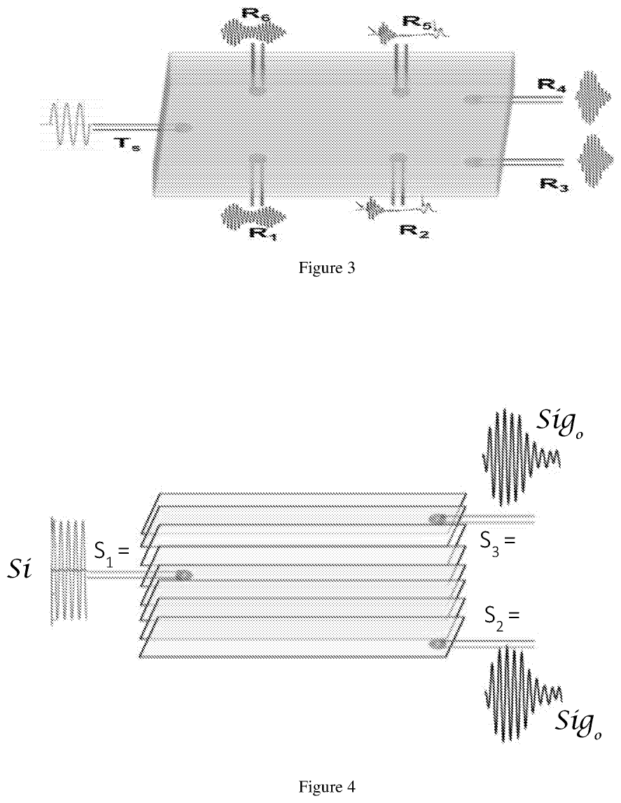

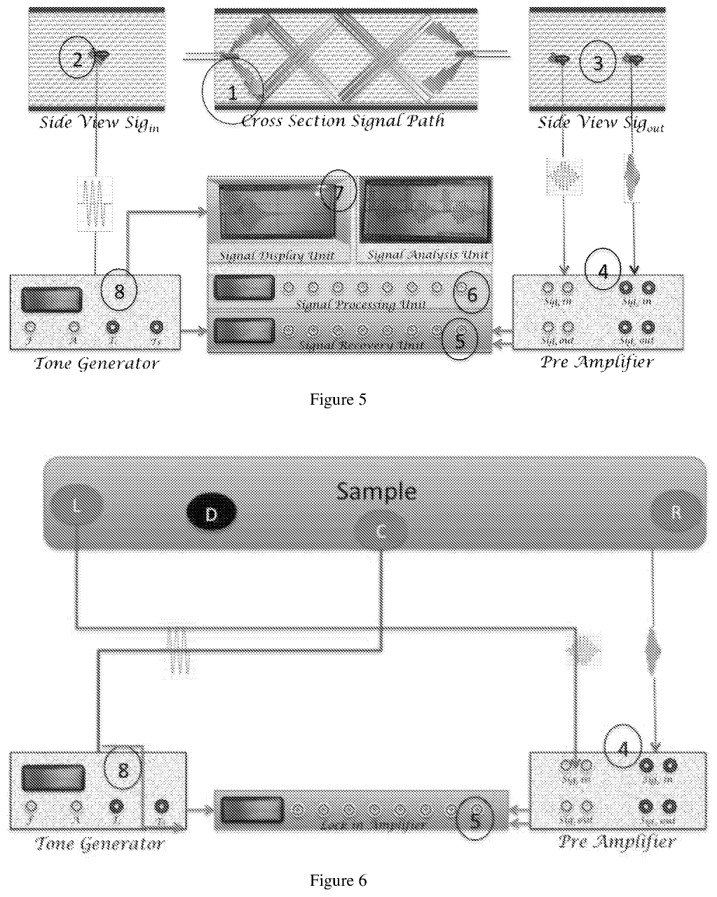

The line in the plot which has been designated as magnitude MILO is an indication of the signal transmitted by the transmitter sensor in the centre to the receiver sensor at the left edge.

The line in the plot which has been designated as magnitude MIRO is an indication of the signal transmitted by the transmitter sensor in the centre to the receiver sensor at the right edge.

Components of the structural health monitoring system for detecting the changes in the material properties of a composite panel:

The Structural Health monitoring system comprises the following:
1. A Composite Panel
2. Transmitter sensor(s)
3. Receiver sensor(s)
4. Pre-Amplifier
5. Signal recovery unit
6. Signal processing unit
7. Measurement Equipment
8. Control unit for the exciter

Wherein the sensors are placed as desired within or on the surface of the composite panel. The sensors can be surface mounted or placed internally at any position within the same layer or different layers in the composite panel.

Wherein the sensors can act as a Transmitter sensor

Wherein the sensors can act as a Receiver sensor

Wherein the pre-amplifier pre-amplifies the signals received by the receiver sensor

Wherein the signal recovery unit recovers the signal amplified by the pre-amplifier.

Wherein the signal processing unit processes the signal recovered by the pre-amplifier.

Wherein the measurement equipment measures wave characteristics such as amplitude, phase, shape and travel time of the signal processed by the signal processing unite.

Wherein the control unit is connected to the Receiver sensor through an electronic interface

Working of the Structural Health Monitoring System

The method by which the invention detects the structural health of the composite panel is as follows:
A continuous periodic wave is transmitted into the composite panel using the Transmitter sensor
The signals from the continuous periodic waves transmitted through the composite panel are received by the receiver sensor.
The signals received by the receiver sensor from the continuous periodic wave is pre-amplified by a pre-amplifier and wave characteristics such as Pass Frequency, amplitude, phase and shape of the received signal is measured using suitable measurement equipment.
The pre-amplifier amplifies the signal received by the receiver sensor
The amplified signal is then recovered by a suitable signal recovery unit
The signal recovered by the signal recovery unit is then processed by a signal processing unit.
The signal processed by the signal processing unit is then analyzed and its characteristics such as Pass Frequency, amplitude, phase and shape are measured using suitable measurement equipment and recorded.
Another aspect of the invention, a wave packet at the selected Pass Frequency is transmitted into the composite panel using the transmitter sensor.

The receiver sensor receives the signal from the wave packet at a selected Pass Frequency transmitted into the composite panel through the transmitter sensor.
The signals received by the receiver sensor from the wave packet at a selected Pass Frequency are pre-amplified by a pre-amplifier and wave characteristics such as amplitude, shape, phase and travel time of the received signal are measured using suitable measurement equipment
The pre-amplifier amplifies the signal received by the receiver sensor
The amplified signal is then recovered by a suitable signal recovery unit
The signal recovered by the signal recovery unit is then processed by a signal processing unit.
The signal processed by the signal processing unit is then analyzed and its wave characteristics such as amplitude, phase, shape and travel time are measured using suitable measurement equipment and recorded to constitute Signature Properties of the composite panel.
The Signature Properties are an indication of material properties such as the interlayer and the intra-layer bonding or lamination strength of the composite panel, and an indicator of distortion or breakage in one or more layers of the composite panel.
In another aspect of the invention, the composite panels are thereafter subjected to the aforementioned system and method after a period of time pursuant to the exposure of the composite panel to an external environment and wave characteristics such as amplitude, phase, shape and travel time of the signals are measured using suitable measurement equipment and recorded to constitute Recorded Properties of the composite panel wherein the measurement equipment
Any variations that may be detected between the Signature Properties and the Recorded Properties such as the travel time, amplitude, phase and shape of the wave packet indicates a deterioration in the current structural health of the composite panel. This in turn would determine the current level of interlayer and the intra-layer bonding or lamination strength of the composite panel or detect distortion or breakage in one or more layers of the composite panel thereby providing an insight into the health condition of the composite panel.
Any change in the interlayer bonding (de-lamination), distortion of individual or multiple panels (distortion) or intra layer strength (breakages) of composite panels directly indicates the change in the material properties of the panels, thereby identifying its structural health.
In another aspect of the invention a wave packet at the selected Pass Frequency is transmitted into the composite panel using the transmitter sensor and received individually by each receiver sensor.
The signals from the wave packet at a selected Pass Frequency and received by each receiver sensor equidistantly placed is pre-amplified by a preamplifier and wave characteristics such as amplitude, shape, phase and travel time of the received signal is measured using suitable measurement equipment
The pre-amplifier amplifies the signal received by each receiver sensor
The amplified signal is then recovered by a suitable signal recovery unit
The signal recovered by the signal recovery unit is then processed by a signal processing unit.
The signal processed by the signal processing unit is then analyzed and its wave characteristics such as amplitude, phase, shape and travel time are measured using suitable measurement equipment and recorded.
Any change in the wave characteristics of the signals received by each receiver sensor is compared and any deviation in the wave characteristics obtained for each sensor indicates a change in the interlayer bonding (de-lamination), or intra layer strength (breakages) to the path through which the wave packet has passed to reach the receiver sensor.
Therefore any change in the interlayer bonding (de-lamination) or intra layer strength (breakages) of composite panels directly indicates the change in the material properties of the panels, thereby indicating a change in its structural health.

### WORKING EMBODIMENT

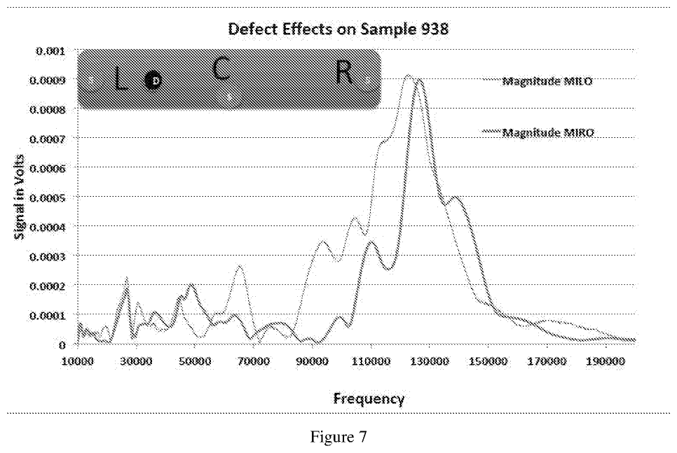

A working embodiment of the invention for the purposes of detecting the structural health of a composite panel is disclosed below. The working embodiment is illustrated with the assistance of FIGS. 6 and 7.
1. A composite panel prepared using High Density Poly Ethylene (‘HDPE_) of s suitable grade is selected and marked as Sample in FIG. 6. The attributes of the composite panel prepared using HDPE are as follows:
a) Thickness—6 millimeters
b) Width—12 centimeters
c) Length—60 centimeters
2. Piezoelectric discs having sensory properties are selected and placed in three suitable positions of the composite panel as described in FIG. 6. Two of the piezoelectric discs are positioned at the left and right corners of the composite panel prepared using HDPE and marked as L and R respectively. The third piezoelectric disc is placed in the center of the composite panel and indicated as C as described in FIG. 6.
3. The piezoelectric discs at L and R are placed in the same layer as and equidistant to the piezoelectric disc at C.
4. The piezoelectric disc at C will act as the transmitter sensor and the piezoelectric discs at and R will act as receiver sensors
5. For the purposes of describing the working embodiment, a defect is positioned between C and L and indicated as D in FIG. 6.
6. The control unit (8) more specifically described as a tone generator in FIG. 6 is connected to the piezoelectric disc at C. A sinusoidal signal which is a continuous periodic wave of 0.5 Volt is then applied to the transmitter sensor and suitable vibrations of the signal are transmitted into the composite panel prepared using HDPE. The frequency of the sinusoidal signal applied at C is varied using the tone generator.
7. These vibrations which are transmitted into the composite panel prepared using HDPE through the piezoelectric disc at C is then received by the piezoelectric discs at L and R.
8. The received signal at L and R is then amplified using a pre-amplifier (4), processed using a signal processing unit, recovered using a signal recovery unit and measured.
9. As described in FIG. 6, a commercially available Lock-in Amplifier has been used to carry out the aforementioned processes of signal processing, recovery and measurement
10. Based on the frequency and amplitude characteristics of the signal recovered, a frequency amplitude plot is generated, and described in FIG. 7. The plot in FIG. 7 shows that the highest peaks for both the signals transmitted from C to L and C to R and marked as MILO and MIRO respectively are obtained at 130000 Hertz indicating the suitable pass frequency at which the signals should be transmitted into the composite panel to detect the structural health of the subject composite panel prepared using HDPE.
11. The different plots obtained and marked as MILO and MIRO in FIG. 7 is recorded and compared. Any deviation of the plot obtained and marked as MILO from MIRO is an indication of a difference to the material properties of the path between C to L due to the presence of defect D.
12. The process is further repeated by sending wave packets such as sinusoidal wave packets instead of continuous periodic waves such as sinusoidal waves at a pass frequency of 130000 Hertz through the piezoelectric disc at C and receiving them at L and R as described in FIG. 7.

1. A structural health monitoring system for detecting the changes in the material properties of a composite panel (1) comprising one or more transmitter sensors (3), one or more receiver sensors (2), a pre-amplifier (4), a signal recovery unit (5), a signal processing unit (6), measurement equipment (7) and control unit for the exciter (8)

2. A structural health monitoring system as claimed in claim 1 wherein the transmitter sensor(s) (3) and the receiver sensors (2) are placed within the composite panel (1).

3. A structural health monitoring system as claimed in claim 1 wherein the transmitter 11, sensor(s) (3) and the receiver sensors (2) are placed on the surface of the composite panel (1).

4. A structural health monitoring system as claimed in claim 1 wherein the transmitter sensor(s) (3) and the receiver sensors (2) are interchangeable.

5. A structural health monitoring system as claimed in claim 1 wherein the transmitter sensor(s) (3) and the receiver sensors (2) are piezoelectric disks.

6. A structural health monitoring system as claimed in claim 1 wherein the receiver sensors (3) are placed equidistant to the transmitter sensor (3) in the composite panel (1).

7. A structural health monitoring system as claimed in claim 6 wherein the receiver sensors (3) are placed on the same layer of the composite panel (1) as the transmitter sensor (3)

8. A method of detecting a change in the structural health of a composite panel, comprising:
(a) recording the Signature Properties of the composite panel prior to its first use, wherein a continuous periodic wave is transmitted into the composite panel (I) using transmitter sensor(s) (2); and wherein the signals from the continuous periodic wave transmitted into a composite panel (1) are received by receiver sensor(s) (3); and wherein the signals received by the receiver sensor(s) (3) from the continuous periodic wave at a selected Pass Frequency and transmitted into the composite panel (1) are pre-amplified by a pre-amplifier (4) and wave characteristics such as amplitude, shape, phase and travel time of the received signal are measured using measurement equipment (7), recovered by a signal recovery unit (5) and recorded as the Signature Properties of the said composite panel (1);
and (b) comparing said Signature Properties of said composite panel (1) after any given period of use, wherein a continuous periodic wave is transmitted into the composite panel (I) using the transmitter sensor(s) (2); and wherein the signals from the continuous periodic wave transmitted into the composite panel (1) are received by the receiver sensor(s) (3); and wherein the signals received by the receiver sensor(s) (3) from the continuous periodic wave at a selected Pass Frequency and transmitted into the composite panel (1) are pre-amplified by a pre-amplifier (4) and wave characteristics such as amplitude, shape, phase and travel time of the received signal are measured using measurement equipment (7) recovered by a signal recovery unit (5) and recorded as the Recorded Properties of the said composite panel (1) and wherein the Signature Properties and the Recorded Properties are compared to indicate the current structural health of the composite panel.

9. The method as claimed in claim 8 wherein the Signature Properties and Recorded Properties of the continuous periodic wave comprise travel time, amplitude, phase and shape of the continuous periodic wave.

10. A method of detecting a change in the structural health of a composite panel (1), comprising:
(a) recording Signature Properties of the composite panel prior to its first use, wherein a wave packet is transmitted into the composite panel (I) using the transmitter sensor(s) (2); and wherein the signals from the wave packet transmitted into the composite panel (1) are received by the receiver sensor(s) (3); and wherein the signals received by the receiver sensor(s) (3) from the wave packet at a selected Pass Frequency and transmitted into the composite panel (1) are pre-amplified by a pre-amplifier (4) and wave characteristics such as amplitude, shape, phase and travel time of the received signal are measured using measurement equipment (7) recovered by a signal recovery unit (5) and recorded as the Signature Properties of the said composite panel (1), and—
and (b) comparing said Signature Properties of said composite panel (1) after any given period of use wherein a wave packet is transmitted into the composite panel (I) using the transmitter sensor(s) (2); and wherein the signals from the wave packet transmitted into the composite panel (1) are received by the receiver sensor(s) (3); and wherein the signals received by the receiver sensor(s) (3) from the wave packet at a selected Pass Frequency and transmitted into the composite panel (1) are pre-amplified by a pre-amplifier (4) and wave characteristics such as amplitude, shape, phase and travel time of the received signal are measured using measurement equipment (7) recovered by a signal recovery unit (5) and recorded as the Recorded Properties of the said composite panel (1) and wherein the Signature Properties and the Recorded Properties such as travel time, amplitude, phase and shape of the wave packet are compared to indicate the current structural health of the composite panel.

11. The method as claimed in claim 10 wherein the Signature Properties and Recorded Properties of the wave packet comprise travel time, amplitude, phase and shape of the wave packet.

12. A method of detecting a change in the structural health of a composite panel (1), comprising:
(a) recording Signature Properties of the composite panel prior to its first use, wherein a continuous periodic wave is transmitted into the composite panel (I) using the transmitter sensor(s) (2); and wherein the signals from the continuous periodic wave transmitted into the composite panel (1) are received by the receiver sensor(s) (3); and wherein the signals received by the receiver sensor(s) (3) from the continuous periodic wave at a selected Pass Frequency and transmitted into the composite panel (1) are pre-amplified by a pre-amplifier (4) and wave characteristics such as amplitude, shape, phase and travel time of the received signal are measured using measurement equipment (7) recovered by a signal recovery unit (5) and recorded as the Signature Properties of the said composite panel (1),
and (b) comparing said Signature Properties of said composite panel (1) after any given period of use wherein a continuous periodic wave is transmitted into the composite panel (I) using the transmitter sensor(s) (2); and wherein the signals from the continuous periodic wave transmitted into the composite panel (1) are received by the receiver sensor(s) (3); and wherein the signals received by the receiver sensor(s) (3) from the continuous periodic wave at a selected Pass Frequency and transmitted into the composite panel (1) are pre-amplified by a pre-amplifier (4) and wave characteristics such as amplitude, shape, phase and travel time of the received signal are measured using measurement equipment (7) recovered by a signal recovery unit (5) and recorded as the Recorded Properties of the said composite panel (1) and wherein the Signature Properties and the Recorded Properties such as travel time, amplitude, phase and shape of the wave packet are compared to indicate the current structural health of the composite panel.

13. The method as claimed in claim 12 wherein the Signature Properties and Recorded Properties of the continuous periodic wave comprise travel time, amplitude, phase and shape of the continuous periodic wave.

14. A method of detecting a change in the structural health of a composite panel (1), comprising:
(a) recording Signature Properties of the composite panel prior to its first use, wherein a wave packet is transmitted into the composite panel (I) using the transmitter sensor(s) (2); and wherein the signals from the wave packet transmitted into the composite panel (1) are received by the receiver sensor(s) (3); and wherein the signals received by the receiver sensor(s) (3) from the wave packet at a selected Pass Frequency and transmitted into the composite panel (1) are pre-amplified by a pre-amplifier (4) and wave characteristics such as amplitude, shape, phase and travel time of the received signal are measured using measurement equipment (7) recovered by a signal recovery unit (5) and recorded as the Signature Properties of the said composite panel (1), and
(b) comparing said Signature Properties of said composite panel (1) after any given period of use wherein a wave packet is transmitted into the composite panel (I) using the transmitter sensor(s) (2); and wherein the signals from the wave packet transmitted into the composite panel (1) are received by the receiver sensor(s) (3); and wherein the signals received by the receiver sensor(s) (3) from the wave packet at a selected Pass Frequency and transmitted into the composite panel (1) are pre-amplified by a pre-amplifier (4) and wave characteristics such as amplitude, shape, phase and travel time of the received signal are measured using measurement equipment (7) recovered by a signal recovery unit (5) and recorded as the Recorded Properties of the said composite panel (1) and wherein the Signature Properties and the Recorded Properties such as travel time, amplitude, phase and shape of the wave packet are compared to indicate the current structural health of the composite panel.

15. The method as claimed in claim 14 wherein the Signature Properties and Recorded Properties of the wave packet comprise travel time, amplitude, phase and shape of the wave packet.
